(19) United States
(12) Patent Application Publication
(10) Pub. No.: US 2016/0125540 A1
(43) Pub. Date: May 5, 2016

(54) SYSTEM AND METHOD OF ANALYSING FINANCIAL RECORDS

(71) Applicant: Data Trends Australia Pty Ltd, Toowong, QL (AU)

(72) Inventor: Wade Dillon Oakley, Bald Hills (AU)

(73) Assignee: Data Trends Australia Pty Ltd, Toowong, QL (AU)

(21) Appl. No.: 14/899,025

(22) PCT Filed: Jun. 20, 2014
(86) PCT No.: PCT/AU2014/000639

§ 371 Date: Dec. 16, 2015

(30) Foreign Application Priority Data
Jun. 21, 2013 (AU) 2013902273

(51) Int. Cl. G06Q 40/06; G06T 11/20

(52) U.S. Cl. CPC G06Q 40/06; G06T 11/206

(57) ABSTRACT

A method of analyzing financial records including receiving, at a server, one or more financial records for a time period, the one or more financial records including one or more transactions, and each transaction including a narrative. The method further includes determining, at the serve, one or more known components within the narrative, generating, at the server, a condensed narrative by removing each known component from the narrative, a remainder being the condensed narrative, generating, at the server, a report including the condensed narrative, and providing the report to a user on a data interface.

### FIELD OF THE INVENTION

This invention relates generally to a system and method of analysing financial records. In particular the invention relates to, but is not limited to, a system and method of analysing financial records and displaying those records in a way that provides the user of the information with a richer understanding of the records based on the users need to understand them.

### BACKGROUND OF THE INVENTION

In order to buy goods, such as televisions, furniture and similar goods, a consumer may obtain a loan from a lender. However, in Australia and in other countries, the lender must complete due diligence before providing the loan. In particular a lender can find some types of loans unsuitable for a consumer if the consumer already has 2 or more similar loans, or the consumer is in default of a similar loan, or if the consumer cannot afford to sustain the loan.

When conducting due diligence the lender typically asks the consumer to provide financial records including bank statements covering the preceding 90 days. The lender then manually analyses the transactions on the bank statements to determine the consumer's financial position including items like income and expenditure and other financial commitments.

In addition or alternatively, the lender may independently obtain the consumer's bank statements, for example through a third party finance data provider. The third party finance data provider may provide a list of financial transactions and assign a category to each transaction, however, due to the complexity and inconsistency of bank transactions categorisation does not satisfy the user's needs and the analysis of bank transactions is often performed manually by the lender.

Manual analysis of bank statements and transactions can be a complex and time consuming task often requiring qualitative assumptions on the part of the person conducting the analysis. This can lead to misinterpretation of the information and under or overstatements that increase the financial, compliance and other risks attached to decisions that are made by the lender based on the analysis. When the lender has multiple sets of transactions to understand, the risk created by manual analysis can be amplified.

There is therefore a need for an improved system and method of analysing a financial record.

The reference to any prior art in this specification is not, and should not be taken as, an acknowledgement or any form of suggestion that the prior art forms part of the common general knowledge in Australia or elsewhere.

### OBJECT OF THE INVENTION

It is an object of some embodiments of the present invention to provide consumers with improvements and advantages over the above described prior art, and/or overcome and alleviate one or more of the above described disadvantages of the prior art and/or provide a useful commercial choice.

### SUMMARY OF THE INVENTION

In one form, although not necessarily the only or broadest form, the invention resides in a method of analysing financial records including the steps of:

receiving, at a server, one or more financial records for a time period, the one or more financial records including one or more transactions, and each transaction including a narrative;

determining, at the server, one or more known components within the narrative;

generating, at the server, a condensed narrative by removing each known component from the narrative, the remainder being the condensed narrative;

generating, at the server, a report including the condensed narrative; and

providing the report to a user on a data interface.

The data interface may be on a computer, a display, a printer, a network interface or any other suitable device.

Preferably, the method includes cleaning the narrative of each transaction to produce a cleaned narrative before determining the one or more known components. Preferably, the method includes identifying known components within the cleaned narrative to produce an identified narrative.

The report may be displayed on a local display, a remote display, or the report may be printed. In addition, the report may include graphs, tables and charts.

In a preferred embodiment, the time period is a previous 90 day time period. However it should be appreciated that the time period may be any time period selected by a user.

Suitably, the method may include allocating a category to each narrative, each cleaned narrative, each known component, each identified narrative, or each condensed narrative.

Preferably, the method includes creating one or more transaction groups according to a same condensed narrative. However it should be appreciated that the one or more transaction groups may be created according to a same narrative, a same cleaned narrative, and/or a same identified narrative.

The method may include determining a time interval between successive transactions in a same transaction group. In addition, the method may include the step of determining a variance in an amount of each transaction within the same transaction group.

Preferably the method includes applying a description to each transaction group. The description may include a precision, a frequency, and a status of the time interval, and a description of the variance.

The precision may describe a number of transactions that have the same time interval. In one embodiment the method includes calculating a percentage of transactions that have a same time interval between consecutive transactions in a same transaction group and applying a description according to the calculated percentage.

The frequency may describe the time interval between each consecutive transaction in the same transaction group.

Each transaction group in the report may include a narrative description that describes the transactions within the transaction group. The narrative description of each transaction group may be derived from the original narrative, the cleaned narrative, the identified narrative or the condensed narrative that is common to all of the transactions within the group, and may additionally include one or more of the components of the identified narrative.

Preferably the report is generated according to a report type. The report type may include rules for determining which transactions to include in the report. The report type may include one or more report sets, each report set being associated with one or more transactions groups. The report set may include rules for selecting the one or more transaction groups.

In one embodiment, the method may include linking transactions between a first financial record, and a second financial record. Preferably, the first and second financial records belong to the same entity. Preferably, transactions are linked by identifying two or more of a same condensed narrative, a same date, and a same amount. The same amount may be a credit in the first financial record and a debit in the second financial record.

In another form, the invention resides in a system for analysing financial records, the system including a server, the server including a processor coupled to a memory, the memory including program code components configured to cause the processor to:

receive one or more financial records for a time period, the one or more financial records including one or more transactions, and each transaction including a narrative;

determine one or more known components within the narrative;

generate a condensed narrative by removing each known component from the narrative, the remainder being the condensed narrative;

generate a report including the condensed narrative; and

providing the report to a user on a data interface.

The data interface may be on a computer, a display, a printer, a network interface or any other suitable device.

The report may be displayed on a local display, a remote display, or the report may be printed. In addition, the report may include graphs, tables and charts.

### BRIEF DESCRIPTION OF THE DRAWINGS

An embodiment of the invention will be described with reference to the accompanying drawings in which:

FIG. 1 illustrates a block diagram of a system for analysing financial records according to an embodiment of the present invention;

FIG. 2 is a flow diagram showing the steps of a method of analysing financial records according to an embodiment of the present invention; and

FIGS. 3-5 show exemplary outputs 300, 400, 500 from a financial report generated according to the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

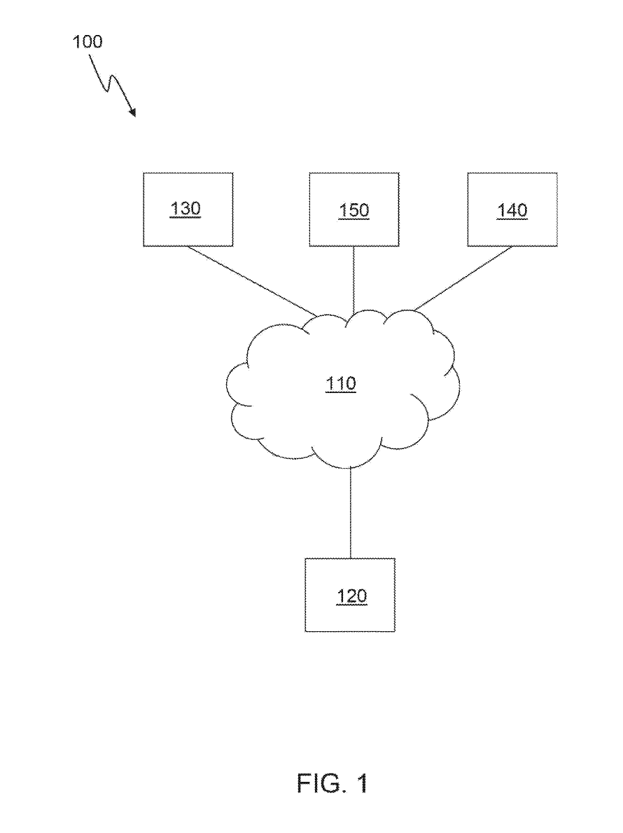

FIG. 1 is a block diagram showing a system 100 for analysing financial records, according to an embodiment of the present invention. The system 100 includes a server 120 connected to the Internet 110. A user in the form of a lender 130 may connect to the server 120 to generate a financial report of financial records belonging to an entity such as a borrower 140. The financial record may be a bank statement obtained from a financial institution 150, such as a bank or a third party financial data provider. However it should be appreciated that the financial record may be any other suitable financial record that can be obtained electronically, for example credit card statements and financial records obtained through bookkeeping software.

Although the present invention is described in relation to providing a financial report of the borrower 140 to the lender 130, it should be appreciated that the financial report may be provided for the benefit of any other suitable interested party, such as a financial counselor, who may wish to determine the spending habits of the entity. It should also be appreciated that the entity may be an individual or a business.

The server 120 includes a memory coupled to a processor, and the memory includes computer readable program code components which are executed by the processor. The program code components are in the form of software installed on a computer readable medium, for example on a hard disk, a random access memory (RAM), or any other applicable computer readable medium. The program code components perform the method of the present invention.

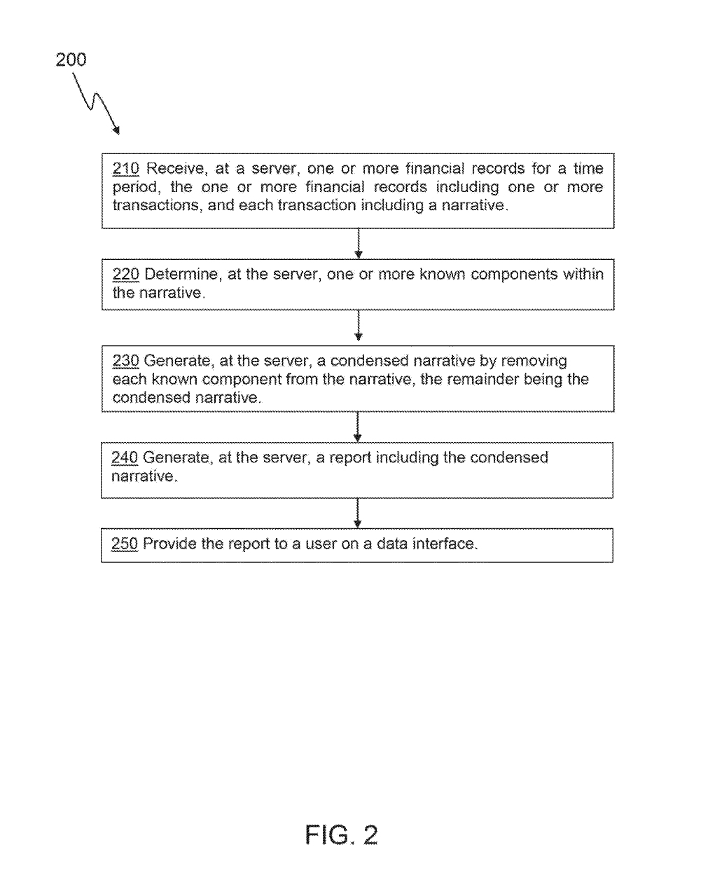

FIG. 2 shows a flow diagram 200 of a method of analysing financial records according to an embodiment of the present invention.

At step 210, the server receives one or more financial records for a time period, the one or more financial records including one or more transactions, and each transaction including a narrative.

At step 220, the server determines, one or more known components within the narrative;

At step 230, the server generates a condensed narrative by removing each known component from the narrative, the remainder being the condensed narrative.

At step 240, the server generates a report including the condensed narrative, and at step 250, the report is provided to a user on a data interface. The data interface may be on a computer, a display, a printer, a network interface or any other suitable device.

The present invention extracts known components from the narrative of the transaction to leave a condensed narrative which may be more easily understood by the reader of the report. For example, a transaction for a purchase at a fast food store may include the store name, the date, a type of transaction and a geographical location. The present invention removes the date, the type of transaction and the geographical location to leave only the store name, together with a transaction date and a transaction amount. Each transaction with the same condensed narrative may be grouped together and further analysed by determining a time interval between transactions in the same group, and a variance in the amount of the transactions in the same group, and applying a meaningful description to the time interval and the variance.

The financial record, or records are obtained electronically for a time period. For example the time period may be a previous 90 days. However it should be appreciated that any suitable time period may be selected by the user of the system 100.

In one embodiment, the financial record is a bank account statement. Bank account statements typically include a number of transactions including items like income and expenditure and other financial commitments. Each transaction includes a date of the transaction, a narrative describing the transaction, an amount of the transaction and whether the transaction is a credit or a debit.

Table 1 below shows a list of transactions received from the financial institution 150, including a narrative, a date, an amount and whether the transaction is a credit or a debit for a time period of a previous 30 days, i.e. the month of June 2013.

TABLE 1
Transactions

| Narrative | Date | Amount | Credit/Debit |
|---|---|---|---|
| Visa Purchase 4Jun Johns | 04-Jun-2013 | 50 | Debit |
| Hardware | | | |
| Visa Purchase 11Jun Johns | 11-Jun-2013 | 50 | Debit |
| Hardware | | | |
| Visa Purchase 14Jun Bunnings | 14-Jun-2010 | 50 | Debit |
| Warehouse | | | |
| Visa Purchase 18Jun Johns | 18-Jun-2013 | 50 | Debit |
| Hardware $50 | | | |
| Visa Purchase 25Jun Johns | 25-Jun-2013 | 50 | Debit |
| Hardware | | | |
| Visa Purchase 25Jun Pizza Hut | 25-Jun-2013 | 50 | Debit |

Once received, the server 120 cleans the narrative of each transaction and generates a cleaned narrative. However it should be appreciated that this step is optional. In some embodiments, such cleaning may include filtering, by removing multiple spaces, and non-visible characters such as tabs and carriage returns. In addition cleaning may include converting lower case characters to uppercase characters.

The server 120 may perform additional cleaning, or filtering, of each narrative by identifying and separating conjoined strings, such as:
a numeric followed by non-numeric, and vice versa, e.g. “1B” may be separated into “1” and “B”;
an alpha-numeric followed by a non-alpha-numeric, and vice versa;
a special character followed by non-special character, and vice versa;
a lowercase alpha-numeric followed by uppercase alpha-numeric; and
specific conjoined words sourced from a lookup table of conjoined words, for example splitting “homerent” into “home” and “rent”.

Table 2 shows a list of cleaned narratives from table 1. As shown in table 2, additional spaces have been removed and each narrative has been converted to capital letters.

TABLE 2
Transactions

| Cleaned Narrative | Date | Amount | Credit/Debit |
|---|---|---|---|
| VISA PURCHASE 4JUN JOHNS | 04-Jun-2013 | 50 | Debit |
| HARDWARE | | | |
| VISA PURCHASE 11JUN | 11-Jun-2013 | 50 | Debit |
| JOHNS HARDWARE | | | |
| VISA PURCHASE 14JUN | 14-Jun-2013 | 50 | Debit |
| BUNNINGS WAREHOUSE | | | |
| VISA PURCHASE 18JUN | 18-Jun-2013 | 50 | Debit |
| JOHNS HARDWARE $50 | | | |
| VISA PURCHASE 25JUN | 25-Jun-2013 | 50 | Debit |
| JOHNS HARDWARE | | | |
| VISA PURCHASE 25JUN PIZZA | 25-Jun-2013 | 50 | Debit |
| HUT | | | |

Once cleaned, the server 120 searches for the cleaned narrative in a database. If the server 120 does not find a match for the cleaned narrative in the database, the server 120 stores the cleaned narrative in the database, and links the transaction to the cleaned narrative in the database. However it should be appreciated that the server 120 may alternatively search for the (original) narrative in the database, and store the narrative in the database.

In the example illustrated in Table 2, it is assumed that none of the cleaned narratives exist in the database. Thus all of the cleaned narratives shown in Table 3 below are added to the database.

TABLE 3
Database - Cleaned Narrative

VISA PURCHASE 4JUN JOHNS HARDWARE
VISA PURCHASE 11JUN JOHNS HARDWARE
VISA PURCHASE 14JUN BUNNINGS WAREHOUSE
VISA PURCHASE 18JUN JOHNS HARDWARE $50
VISA PURCHASE 25JUN JOHNS HARDWARE
VISA PURCHASE 25JUN PIZZA HUT

When a cleaned narrative is added to the database the server 120 identifies known components within the cleaned narrative (or original narrative) to produce an identified narrative. The server 120 searches the database for the identified narrative. If the identified narrative is found in the database, the cleaned narrative is linked to the identified narrative. Known components may include strings that are commonly used by financial institutions when producing a narrative of a transaction. Furthermore, additional known components may be stored in a component list.

In one example, a known component of an identified narrative may be a description of a type of transaction, for example “VISA PURCHASE”, “INTERNET WITHDRAWAL”, or “EFTPOS PURCHASE”.

Other known components of an identified narrative may include computational textual patterns such as numbers, special characters (for example $, #, and %), a date, a month, a time of day, masked data indicators (for example “XXXX” which may hide personal identifying information), single letters, and a geographical location (for example “BRISBANE” or “SYDNEY”) which are commonly used by financial institutions in the narrative of a transaction. In addition, the server 120 may use positional matching criteria within the narrative to identify a known component within the narrative. For example the known component may comprise of multiple strings, for example “ATM Woolworths Brisbane WITHDRAWAL”. The “ATM” at the start of the narrative and the “WITHDRAWAL” appearing at the end of the narrative may together be a known component. Table 4 below shows identified narratives, including the known components (known components are shown in curly brackets{ }) identified within the clean narrative from Table 3.

TABLE 4
Database - Identified Narrative

{Method} {Date} JOHNS HARDWARE
{Method} {Date} BUNNINGS WAREHOUSE
{Method} {Date} JOHNS HARDWARE {special char} {Number}
{Method} {Date} PIZZA HUT

Once the identified narrative has been created from the cleaned narrative, the server 120 generates a condensed narrative by removing the identified components from the identified narrative, the remainder being the condensed narrative. The server 120 searches the database for the condensed narrative. If a condensed narrative is found, the identified narrative is linked to the condensed narrative in the database. If the condensed narrative is not found in the database, the condensed narrative is added to the database and linked to the identified narrative.

Table 5 shows condensed narratives generated from the identified narrative from table 4, and table 6 shows an exemplary database including the clean narrative, the identified narrative (with components of the identified narrative in curly brackets{ }) and the condensed narrative.

TABLE 5
Database - Condensed Narrative

JOHNS HARDWARE
BUNNINGS WAREHOUSE
PIZZA HUT

TABLE 6
Database Listing

| | | Condensed |
|---|---|---|
| Cleaned Narrative | Identified Narrative | Narrative |
| VISA PURCHASE | {Method} {Date} JOHNS | JOHNS |
| 4JUN JOHNS | JOHNS HARDWARE | HARDWARE |
| HARDWARE | | |
| VISA PURCHASE | {Method} {Date} JOHNS | JOHNS |
| 11JUN JOHNS | HARDWARE | HARDWARE |
| HARDWARE | | |
| VISA PURCHASE | {Method} {Date} | BUNNINGS |
| 14JUN BUNNINGS | BUNNINGSWAREHOUSE | WAREHOUSE |
| WAREHOUSE | | |
| VISA PURCHASE | {Method} {Date} JOHNS | JOHNS |
| 18JUN JOHNS | HARDWARE {special char} | HARDWARE |
| HARDWARE $50 | {Number} | |
| VISA PURCHASE | {Method} {Date} JOHNS | JOHNS |
| 25JUN JOHNS | HARDWARE | HARDWARE |
| HARDWARE | | |
| VISA PURCHASE | {Method} {Date} PIZZA HUT | PIZZA HUT |
| 25JUN PIZZA HUT | | |

Once in the database, each cleaned narrative, each identified narrative, and each condensed narrative may reference one or more aliases. An alias is a way of treating two different strings as being the same. For example if the string “ATM WITHDRAWAL.” is aliased to “ATM WDL” then these two strings are treated as the same string.

The original transaction, each cleaned narrative, each identified narrative and each condensed narrative may be allocated zero or more categories. Exemplary categories include salary, rent, food, fast food, loans, living expenses, clothing and any other category that may be required. However it should be appreciated that a category infers an interpretation of the text that may not always be correct. For example, “John Rent” may be allocated to the category Rent, but the text John Rent could also refer to John's rent, another person named John whose rent is paid to the bank account owner, or the surname “Rent”. In addition, the transaction could be money associated with the rental of an appliance, the repayment of a loan, or any other reason that has meaning to the originator of the text. The assignment of a category assists a user to identify which transactions to include in a report set, which is described below.

Once each transaction has been linked to a cleaned narrative, the cleaned narrative has been linked to an identified narrative and the identified narrative has been linked to a condensed narrative, the server 120 may generate a report according to a report type selected by a user. The report type includes a set of rules that defines how the user wishes to interpret the financial records. The rules include which report sets are to be included, and the physical layout and appearance of the final report including the specific features required in the report. The report type allows for dynamic building of reports tailored to the user's requirements. For example it allows (as in this embodiment) a report to be generated for a lender 130 that contains a breakdown of loans and other information that is relevant to the lender 130. However, a financial counselor may require an entirely different report that focuses on living expenses and bills. The selection of a report type allows this flexibility.

A report set also includes rules for selecting which transactions to include in the report for further analysis. The rules may include any characteristic such as a transaction type (credit/debit), a category of the transaction, components of the identified narrative, amounts of the transaction, date ranges, and transaction frequencies. It should be appreciated that rules can be applied to an individual transaction and/or to a transaction group. It should be appreciated that some rules can only be applied before the transaction is allocated to a transaction group as those transactions apply to transaction properties (i.e. credit/debit, transaction date). However some rules can only apply once the transaction has been allocated to a transaction group such as frequency. In addition, it should be appreciated that some rules can apply to both individual transactions and transactions in a transaction group. For example an amount of an individual transaction and the sum of transaction amounts in a transaction group. For example, a lender 130 may define a report set as being “Income—Salary”, which will have the rules of:

transactions that are credits AND

transactions that have a category of “Salary” OR

transactions that have a transaction group total amount larger than 50.

Thus all transactions that meet the rules will be included in the report set.

Once the report type has been selected, the server 120 identifies all transactions that meet the report set rules for inclusion within the report sets.

For each report set, transaction groups are created by the server 120. Transaction groups include transactions that are specified by the report set and also linked to the same condensed narrative. However it should be appreciated that the server 120 may group transactions according to the same clean narrative or the same identified narrative.

Once each transaction has been placed into a transaction group, the server 120 may determine a time interval between successive transactions in the same transaction group. In addition, the server 120 may determine a variance in the amount between all transactions in the same transaction group.

Table 7 below shows transaction groups identified from the transactions shown tables 1-6.

TABLE 7
Transactions to Groups

| | | | Time | |
|---|---|---|---|---|
| | | Condensed | Inter- | Amount |
| Group | Clean Narrative | Narrative | val | Variance |
| 1 | VISA PURCHASE 4JUN | JOHNS | — | — |
| | JOHNS HARDWARE | HARDWARE | | |
| 1 | VISA PURCHASE 11JUN | JOHNS | 7 | 0 |
| | JOHNS HARDWARE | HARDWARE | | |
| 1 | VISA PURCHASE 18JUN | JOHNS | 7 | 0 |
| | JOHNS HARDWARE $50 | HARDWARE | | |
| 1 | VISA PURCHASE 25JUN | JOHNS | 7 | 0 |
| | JOHNS HARDWARE | HARDWARE | | |
| 2 | VISA PURCHASE 14JUN | BUNNINGS | — | — |
| | BUNNINGS | WAREHOUSE | | |
| | WAREHOUSE | | | |
| 3 | VISA PURCHASE 25JUN | PIZZA HUT | — | — |
| | PIZZA HUT | | | |

The server 120 then determines a pattern in the time interval and/or the amount variance. Once a pattern between transactions in a group has been established, the server 120 may apply a description to the pattern. The description may apply to the time interval between consecutive transactions and/or the variance in the amount of the transactions within the same transaction group.

The description may describe a precision, a frequency and a status of the time interval between transactions in a transaction group.

The precision describes the number of transactions that have the same time interval. The server 120 determines a percentage of transactions that have the same time interval between consecutive transactions in the same transaction group, and applies the description according to the calculated percentage. For example, if 100% of the transactions in the same transaction group have the same time interval, the description may be “Exactly”. If between 75% and 99% of transactions in the same transaction group have the same time interval, the description may be “Mostly”. If between 50% and 74% of transactions in the same transaction group have the same time interval the description may be “Sometimes”. If less than 50% of transactions in the same transaction group have the same time interval, the description may be “Irregular”.

The frequency describes the time interval in days between each consecutive transaction. However it should be appreciated that the time interval may be in another suitable unit. For example, if the time interval is zero days, all of the transactions occurred on the same day, thus the description may be “Same Day”. If the time interval between consecutive transactions occurs on successive days, the description may be “Daily”. If the time interval between consecutive transactions occurs every week, the description may be “Weekly”. If the time interval between consecutive transactions is every 2 weeks, the description may be “Fortnightly”. If the time interval between consecutive transactions is every month, the description may be “Monthly”. If the transaction occurs once, the description may be “Once-Off”. Alternatively, the description may describe a number of days or weeks between successive transactions, for example “Every X days” or “Every X Weeks”.

The status of the time interval between consecutive transactions describes whether the transactions in a transaction group are ongoing, have started during the time period, have stopped during the time period, or have started and stopped during the time period. The status is calculated by the server 120 by analysing the date of the first transaction, the date of the last transaction, the time interval between consecutive transactions, an average time interval between consecutive transactions and the reliability calculated above. For example if a reliable weekly pattern was detected and the first transaction date was less than a week from the start date of the financial transaction period and the last transaction date was three weeks before the end date of the financial transaction period then this would be calculated as ‘Stopped’.

In addition the server 120 may identify the date of the first transaction and the date of the last transaction within the transaction group to provide additional information for a reader of the report.

Each transaction group in the report includes a narrative description that describes all transactions within the group. The narrative description of each transaction group is derived from the original narrative, the cleaned narrative, the identified narrative or the condensed narrative that is common to all of the transactions within the group and may additionally include one or more of the components of the identified narrative. For example, one or more components of the identified narrative may be added to the condensed narrative to provide a meaningful description of the transactions within the transaction group. For example, if the condensed narrative is “MCDONALDS” and one transaction within the same transaction group includes an identified component of “EFTPOS” and another transaction within the same transaction group includes an identified component of “VISA PURCHASE” then the final description of the transaction group may be displayed as “MCDONALDS (EFTPOS, VISA PURCHASE)”, — this indicates to the user that both EFTPOS and VISA was used for the “MCDONALDS” transactions.

A financial report may be generated according to the report type selected by the user. The financial report may be displayed on a local display, on a remote display, or printed. The financial report contains information defined by the report type. The report may include a summary, overview and statement.

The summary may include information that relates to the financial record such as account number, account name, account type, account holder name, total credits, total debits, current balance, a previous day's balance and number of days the account was in a negative balance.

The overview may include headings and sub headings made up of the report sets and displayed as defined by the report type rules. Within each report set, each group may be displayed with information including;
the group description;
a number of transactions;
a precision;
the frequency;
the status;
a total debit amount;
a total credit amount;
a monthly amount;
a day of the week;
a date range of transactions within a transaction group; and
the variance of the amount within the transaction group.

A statement may include a list of all transactions including date, credit amount, debit amount, narrative and running total. In addition if a transaction is included in a report set then a descriptive may identify this and a visual aid such as a colour code may be used to identify transactions in the same or similar record sets as defined by the report type

Additional features may be included within the summary, overview or transaction as defined by the report type to convey the information contained in the report in a more easily understood way. For example a pie chart showing the breakdown of debits or credits, or a graph showing an accounts balance changes over the last 90 days.

The present invention allows the lender 130 to have access to information contained within a financial record in an easy to understand manner such that the lender 130 can incorporate the report into their process for calculating credit worthiness, meeting legislative requirements or achieving operational objectives.

The report type may also specify the format for the report such as a PDF, Xml, Html, or any other suitable electronic format. The server 120 generates the report in the selected format, and sends the report to the lender 130 by email, a web service, an end user application integration, an online web interface, or any other suitable electronic delivery method.

Table 8 shows a report generated including a description of the time interval, the variance in the amount of the transactions group, and a meaningful description applied to the transaction group.

TABLE 8
Groups - Meaningful Information

| Group | Group Description | # | Precision | Frequency | Status |
|---|---|---|---|---|---|
| 1 | JOHNS HARDWARE | 4 | Exactly | Weekly | Ongoing |
| | (VISA PURCHASE) | | | | |
| 2 | BUNNINGS | 1 | | Once-Off | |
| | WAREHOUSE | | | | |
| | (VISA PURCHASE) | | | | |
| 3 | PIZZA HUT (VISA | 1 | | Once-Off | |
| | PURCHASE) | | | | |

As shown in Table 8, the server 120 has grouped transactions made at a same store. In the case of JOHNS HARDWARE, 4 transactions were identified that occurred exactly 1 week apart, thus the description of the precision has been described as “Exactly”, and the frequency has been described as “Weekly”. In addition, as the last transaction occurred less than a week from the date of the report, the server 120 has identified the status of the transaction as “Ongoing”. If the last transaction was identified as being more than a week from the date of the report, the server 120 may identify the status to be “Stopped”.

In addition, the group description is comprised of the common condensed narrative, along with the components of the identified narrative. However it should be appreciated that the group description may be chosen from any common combination of the clean narrative, the identified narrative and the condensed narrative along with any combination of the components of the identified narrative.

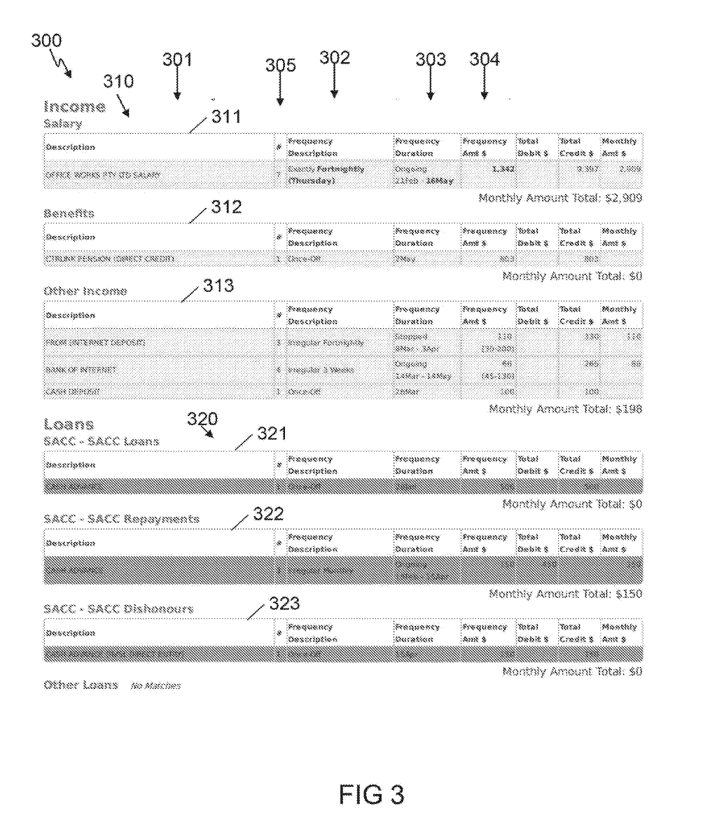

FIGS. 3-5 show exemplary outputs 300, 400, 500 from a financial report generated according to the present invention.

FIG. 3 shows tables of income and loans. Income 310 may be split up into report sets including a salary 311, benefits 312, and other income 313. Loans 320 may be split up into loan advanced amount 321, loan repayments 322, and dishonoured loan payments 323. Each report set contains zero or more transaction groups. As shown in FIG. 3 each table includes a number of columns including a narrative description 301, derived from the condensed narrative and components of the identified narrative, frequency description 302, comprised of the precision, the frequency and the common day of the week of the transactions, a status description 303, comprised of the status and the date range of transactions within the group, a variance 304, comprised of the average frequency amount and the amount range of the transactions within the group, and a number of transactions in a transaction group 305.

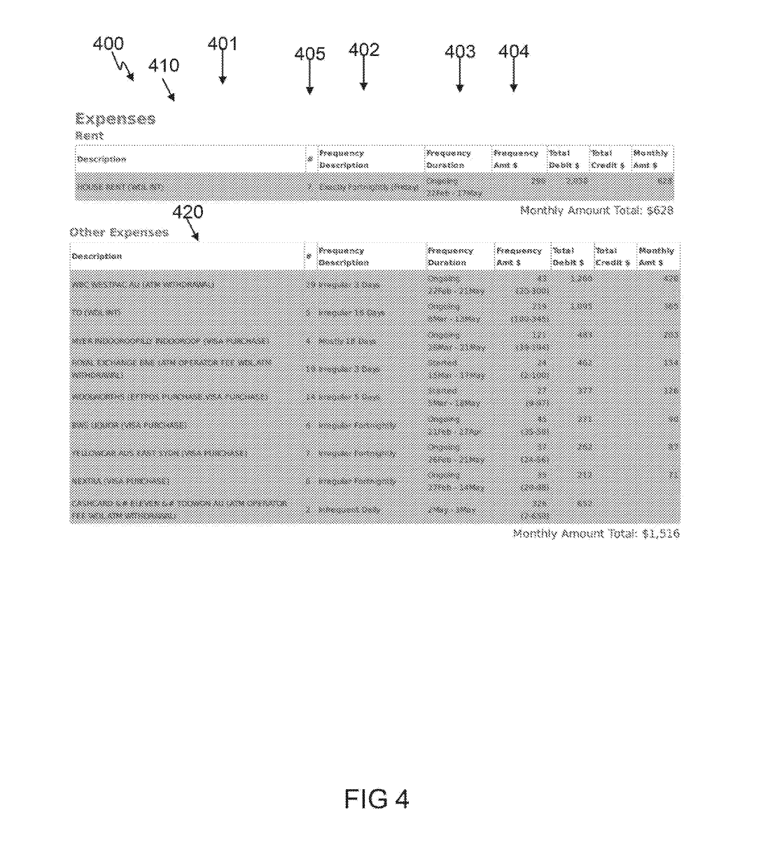

FIG. 4 shows tables of expenses. Similar to income above, the expenses are split into report sets including rent 410 and other expenses 420. As shown in FIG. 4, other expenses 420 are split into further transaction groups. In addition each table includes a number of columns including a narrative description 401, derived from the condensed narrative and an identified narrative, frequency description 402, comprised of the precision, the frequency and the common day of the week of the transactions, a status description 403, comprised of the status and the date range of transactions within the group, a variance 404, comprised of the average frequency amount and the amount range of the transactions within the group, and a number of transactions 405 in a transaction group.

As shown in FIGS. 3 and 4, instances where the variance 304, 404 in the amount is greater than zero, the amount of variance may be shown in brackets ( ), together with an average. For example, if three transactions in a same transaction group are $50, $52, and $54, the variance between the transactions is displayed as (50-54) and the average is displayed as $52.

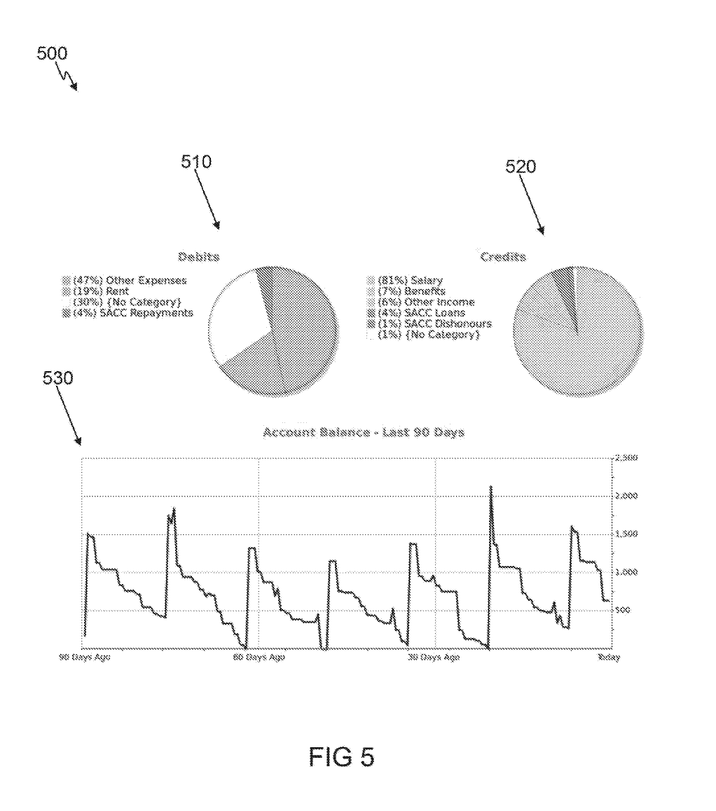

In addition, it should be appreciated that the report may include graphical representations. FIG. 5 shows a pie chart 510 of sources of debit transactions, a pie chart 520 of sources of credit transactions, and a graph 530 of an account balance as it changes throughout the time period.

It should be appreciated that the present invention may also be used to track transactions between a first financial record, and a second financial record. The first and second financial records may belong to a same entity. The transactions may be linked by identifying two or more of a same condensed narrative, a same date, and a same amount. The same amount may be a credit in the first financial record and a debit in the second financial record.

In summary, the present invention produces a financial report of an entity which can be tailored to a user. The report groups together similar transactions in a financial record, and provides a meaningful description for similar transactions. As such, a reader of a report can spend less time and achieve a more precise and consistent outcome when conducting due diligence.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. This patent specification is intended to embrace all alternatives, modifications and variations of the present invention that have been discussed herein, and other embodiments that fall within the spirit and scope of the above described invention.

1. A method of analysing financial records including:
receiving, at a server, one or more financial records for a time period, the one or more financial records including one or more transactions, and each transaction including a narrative;
determining, at the server, one or more known components within the narrative;
generating, at the server, a condensed narrative by removing each known component from the narrative, a remainder being the condensed narrative;
generating, at the server, a report including the condensed narrative; and
providing the report to a user on a data interface.

2. The method of claim 1 including cleaning the narrative to produce a cleaned narrative before determining the one or more known components within the narrative.

3. The method of claim 2 including identifying known components within the cleaned narrative to produce an identified narrative.

4. The method of claim 1 including allocating a category to each condensed narrative.

5. The method of claim 1 including creating one or more transaction groups according to a same condensed narrative.

6. The method of claim 5 including determining a time interval between successive transactions in a same transaction group.

7. The method of claim 5 including determining a variance in an amount of each transaction within a same transaction group.

8. The method of claim 5 including applying a description to each transaction group.

9. The method of claim 8 wherein the description of each transaction group includes at least one of a precision, a frequency, and a status of the time interval

10. The method of claim 7 including a description of the variance.

11. The method of claim 9 wherein the precision describes a number of transactions that have the same time interval.

12. The method of claim 6 further including calculating a percentage of transactions that have a same time interval between consecutive transactions in the same transaction group to produce a calculated percentage, and applying a description according to the calculated percentage.

13. The method of claim 5 wherein each transaction group in the report includes a narrative description that describes the transactions within the transaction group.

14. The method of claim 13 wherein the narrative description of each transaction group is derived from the original narrative, the cleaned narrative, the identified narrative or the condensed narrative that is common to all of the transactions within the group.

15. The method of claim 1 wherein the report is generated according to a report type.

16. The method of claim 15 wherein the report type include rules for determining which transactions to include in the report.

17. The method of claim 15 wherein the report type includes one or more report sets, each report set being associated with one or more transactions groups.

18. The method of claim 17 wherein the report set includes rules for selecting the one car more transaction groups.

19. The method of claim 1 including linking transactions between a first financial record, and a second financial record.

20. A system for analysing financial records, the system including a server, the server including a processor coupled to a memory, the memory including program code components configured to cause the processor to:
receive one or more financial records for a time period, the one or more financial records including one or more transactions, and each transaction including a narrative;
determine one or more known components within the narrative;
generate a condensed narrative by removing each known component from the narrative, the remainder being the condensed narrative;
generate a report including the condensed narrative; and
providing the report to a user on a data interface.
